(19) United States
(12) Patent Application Publication
(10) Pub. No.: US 2012/0138827 A1
(43) Pub. Date: Jun. 7, 2012

(54) ELECTRIC WASTE GATE ACTUATOR FOR TURBOCHARGER

(75) Inventor: Jin Ra KIM, Gyeonggi-do (KR)

(73) Assignee: MANDO CORPORATION

(21) Appl. No.: 13/312,528

(22) Filed: Dec. 6, 2011

(30) Foreign Application Priority Data
Dec. 7, 2010 (KR) 10-2010-0123922

(51) Int. Cl. F02B 37/18; F02D 23/00; F16K 31/04

(52) U.S. Cl. 251/129.11

(57) ABSTRACT

Provided is an electric waste gate actuator for a turbocharger, which includes a return spring for assisting a retention force of a final output gear, and a stopper for adjusting a rotation angle of the final output gear, thereby reducing an amount of a current consumed for maintaining the final output gear at a constant position. The electric waste gate actuator for a turbocharger includes: a housing having an installation space formed by a body and a cover; a driving motor installed within the installation space; a decelerator including gear trains provided with a plurality of gears, such that the decelerator is coupled to a lever installed outside the housing and transmits power of the driving motor; and an elastic member cooperating with the driving motor so as to maintain a rotation angle of a final output gear for finally transmitting power to the lever among the gear trains.

### CROSS-REFERENCE(S) TO RELATED APPLICATION

This application claims priority of Korean Patent Application No. 10-2010-0123922, filed on Dec. 7, 2010, in the Korean Intellectual Property Office, which is hereby incorporated by reference in its entirety.

### BACKGROUND OF THE INVENTION

1. Field of the Invention

The present invention relates to an electric waste gate actuator for a turbocharger, and more particularly, to an electric waste gate actuator for a turbocharger, which includes a return spring for assisting a retention force of a final output gear, and a stopper for adjusting a rotation angle of the final output gear, thereby reducing an amount of a current consumed for maintaining the final output gear at a constant position.

2. Description of the Related Art

Generally, power generated by an internal combustion engine is dependent on a mass of air and an amount of fuel that may be supplied to the internal combustion engine. In order to increase the power of the internal combustion engine, it is necessary to supply a larger amount of combustion air and fuel. The increase in the power of the internal combustion engine may be achieved by increasing a cubic capacity or rotational speed of an intake engine. However, the increase in the cubic capacity leads to an expensive internal combustion engine having a relatively heavy weight and a large size. In particular, the increase in the rotational speed accompanies serious problems and disadvantages in a relatively large internal combustion engine.

Supercharging has been often adopted as a technical solution to increasing the power of the internal combustion engine. Supercharging refers to precompressing combustion air using an exhaust gas turbocharger or a compressor mechanically driven by an engine. The exhaust gas turbocharger basically includes a turbine and a compressor connected to a common shaft and rotating at a constant rotational speed. The turbine converts uselessly exhausted energy into rotational energy through exhaust gas. The turbine drives the compressor. The compressor sucks new air and supplies precompressed air to individual cylinders of an engine. An increased amount of fuel is supplied to a relatively large amount of air in the cylinder. As a result, the internal combustion engine outputs higher power. Therefore, a combustion process is additionally influenced preferably, and the internal combustion engine has a higher total efficiency level. In addition, a torque profile of the internal combustion engine, which is supercharged by the turbocharger, may be formed very preferably.

Since a series induction motor from a vehicle manufacturer uses an exhaust gas turbocharger, it may be considerably optimized without a structural interference with an internal combustion engine over a wide range. Generally, the supercharged internal combustion engine has a relatively low specific fuel consumption and a lower pollutant emission rate. Furthermore, since the exhaust gas turbocharger itself acts as an additional silencer, the turbo engine is silent at the same power level as compared to a typical intake engine.

In an internal combustion engine having a wide rotational speed range (for example, an internal combustion engine for a car), a high charging pressure is required at a low rotational speed of an engine. To this end, a charging pressure control valve, called a waste gate valve, has been applied to a turbocharger. By selecting a relevant turbine casing, a high charging pressure is formed at a low rotational speed of an engine. The waste gate valve limits a charging pressure to a predetermined level according to the increase in the rotational speed of an engine.

In the conventional electric waste gate actuator having the above-described functions, power for rotating a final output gear is derived from only a driving force of a motor. Therefore, a large amount of a current is consumed so as to maintain the final output gear at a constant position.

### SUMMARY OF THE INVENTION

An aspect of the present invention is directed to an electric waste gate actuator for a turbocharger, which includes a return spring for assisting a retention force of a final output gear, and a stopper for adjusting a rotation angle of the final output gear, thereby reducing an amount of a current consumed for maintaining the final output gear at a constant position.

According to an embodiment of the present invention, an electric waste gate actuator for a turbocharger includes: a housing having an installation space formed by a body and a cover; a driving motor installed within the installation space; a decelerator including gear trains provided with a plurality of gears, such that the decelerator is coupled to a lever installed outside the housing and transmits power of the driving motor; and an elastic member cooperating with the driving motor so as to maintain a rotation angle of a final output gear for finally transmitting power to the lever among the gear trains.

The cover may include: an insertion hole into which a rotational shaft of the final output gear is inserted; and a groove portion formed around the insertion hole, such that the elastic member is disposed at the groove portion.

The elastic member may be a coil spring, one end of which is disposed within a concave portion formed at one side of the groove portion, and the other end of which is fixed the final output gear, such that the coil spring generates a restoring force when the final output gear is rotated.

The cover may include a stopper protruding on a rear surface thereof around an insertion hole in which a rotational shaft of the final output gear is inserted. The final output gear may include a protrusion portion. Accordingly, the rotation of the final output gear may be restricted by a contact between the protrusion portion and the stopper.

The electric waste gate actuator may further include: a magnet installed at one end of a rotational shaft of the final output gear within the housing; a sensor installed in installation space under the magnet within the housing and measuring the rotation angle of the final output gear by sensing a variation in a flux of the magnet; and an electronic control unit (ECU) installed in the housing outside the installation space.

### BRIEF DESCRIPTION OF THE DRAWINGS

FIG. 1 is an exploded perspective view showing an electric waste gate actuator for a turbocharger according to an embodiment of the present invention.

FIG. 2 is a partial cut-away cross-sectional view schematically showing the electric waste gate actuator for a turbocharger according to the embodiment of the present invention.

FIG. 3A is a perspective view showing a bottom of a cover, in which a return spring is disposed, in the electric waste gate actuator for a turbocharger according to the embodiment of the present invention.

FIG. 3B is a perspective view showing the bottom of the cover, in which a final output gear is disposed, in the electric waste gate actuator for a turbocharger according to the embodiment of the present invention.

<Reference Numerals>

| | |
|---|---|
| 10: housing | 11: cover |
| 11b: concave portion | 11c: stopper |
| 20: blocking plate | 30: driving motor |
| 40: sensor unit | 50: decelerator |
| 55: return spring | 55a: one end of return spring |
| 55b: the other end of return spring | 60: ECU |
| G: final output gear | S: rotational shaft of final output gear |

### DETAILED DESCRIPTION OF EXEMPLARY EMBODIMENTS

Exemplary embodiments of the present invention will be described below in detail with reference to the accompanying drawings. However, the present invention should not be construed as being limited to the exemplary embodiments set forth herein. Throughout the disclosure, like reference numerals refer to like parts throughout the drawings and embodiments of the present invention.

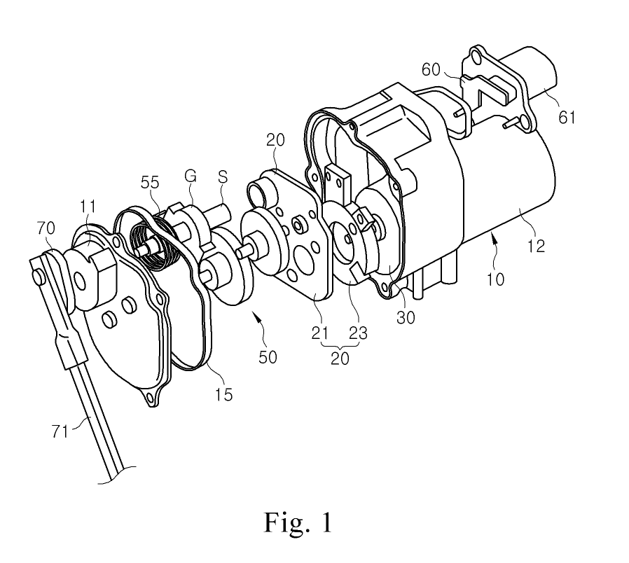

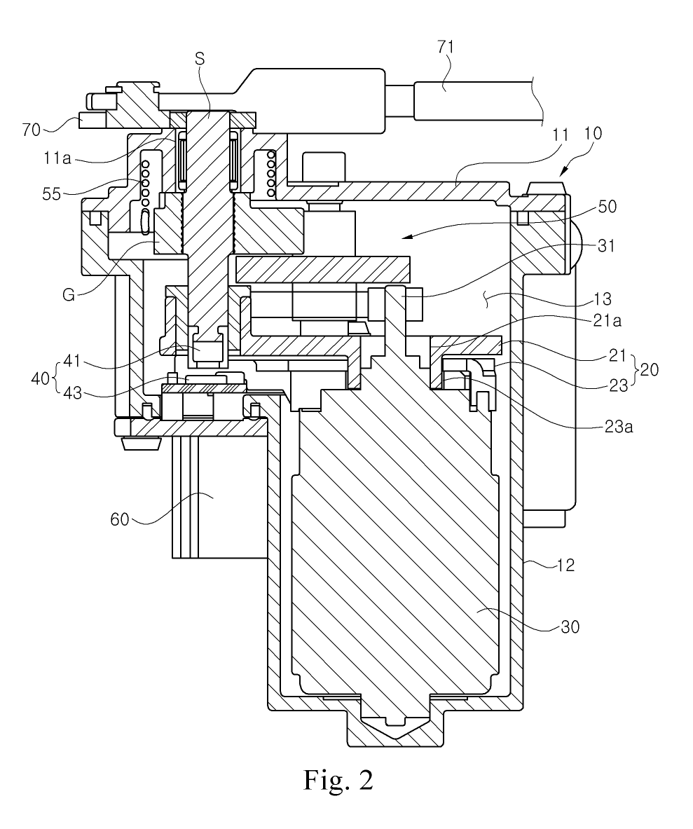

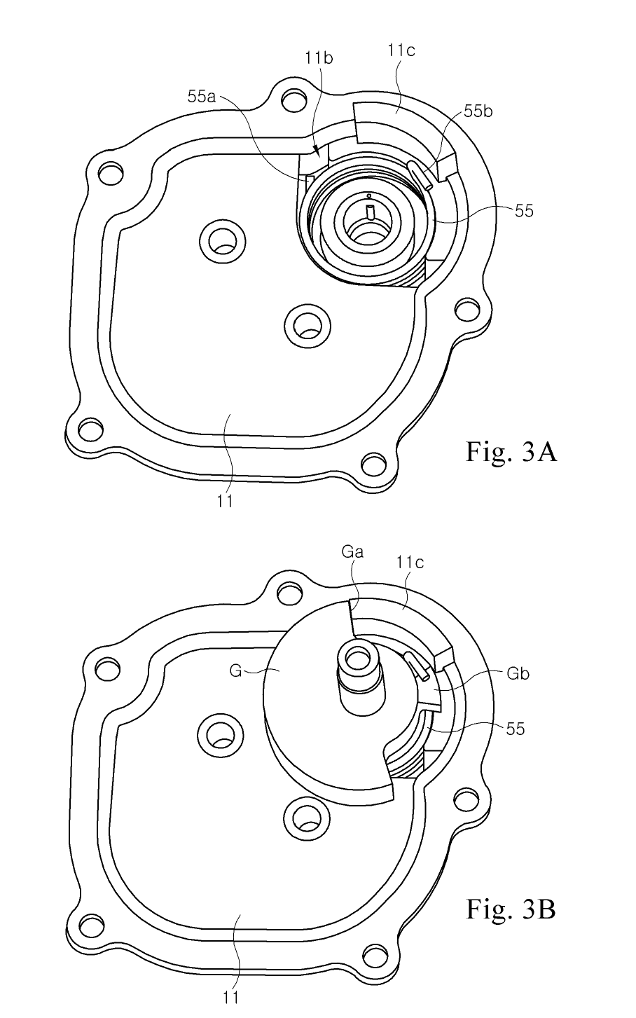

FIG. 1 is an exploded perspective view showing an electric waste gate actuator for a turbocharger according to an embodiment of the present invention. FIG. 2 is a partial cut-away cross-sectional view schematically showing the electric waste gate actuator for a turbocharger according to the embodiment of the present invention. FIG. 3A is a perspective view showing a bottom of a cover, in which a return spring is disposed, in the electric waste gate actuator for a turbocharger according to the embodiment of the present invention. FIG. 3B is a perspective view showing the bottom of the cover, in which a final output gear is disposed, in the electric waste gate actuator for a turbocharger according to the embodiment of the present invention.

For reference, it should be noted that FIG. 2 is a partial cut-away view of an electric waste gate actuator for a turbocharger according to an embodiment of the present invention, and thus, a part of a decelerator is not shown herein.

In addition, it should be noted that the following description will be made with reference to FIG. 2, focusing on installation directions of elements.

Referring to FIGS. 1 and 2, an electric waste gate actuator for a turbocharger according to an embodiment of the present invention includes a housing 10 having an installation space 13 inside. A decelerator 50 is installed in an upper portion of the installation space 13. A lever 70 is installed in the exterior such that the lever 70 is coupled to an upper end of the decelerator 50. A driving motor 30 is installed in a lower portion of the installation space 13. A blocking plate 20 divides the installation space into the upper portion and the lower portion. An electronic control unit (ECU) 60 is installed at the outer periphery of the housing 10.

The housing 10 includes a cylindrical body 12 and a cover 11. The body 12 has an opened upper end and forms the installation space 13. The cover 11 closes the opened upper end of the body 12. The cover 11 has a plate shape, and an insertion hole 11a is formed at one side of the cover 11.

The driving motor 30 is installed in the lower portion of the installation space 13 and generates a torque. A sealing member 15 is disposed between the cover 11 and the body 12 and seals a gap between the cover 11 and the body 12.

In FIGS. 1 and 2, although reference numerals are assigned to a final output gear a rotational shaft S of the final output gear and a return spring 55 as an elastic member, the decelerator 50 includes a plurality of gears forming gear trains, a plurality of rotational shafts forming shafts of the gears, and a return spring 55. A motor shaft 31 extends toward the upper portion of the installation space 13, and is organically coupled to the gear located in a lower portion among the gears of the decelerator 50. The decelerator 50 coupled to the motor shaft 31 generates a relatively higher torque than that generated by the driving motor 30. Meanwhile, the rotational shaft S disposed at the upper portion passes through the insertion hole 11a and is exposed to the exterior, and the upper portion of the exposed rotational shaft S is coupled to the lever 70. Therefore, the decelerator 50 may transmit a torque to the turbocharger (not shown) through a load 71.

The blocking plate 20 includes a motor terminal 23 and a plate 21. The motor terminal 23 has a plate shape in which a first through-hole 23a is drilled. The motor terminal 23 is closely installed at the upper end of the driving motor 30, such that the motor terminal 23 fixes the position of the driving motor 30 and the plate 21 is closely installed on the top surface of the motor terminal 23. The plate 21 has a plate shape in which a second through-hole 21a is drilled. The plate 21 is closely installed on the top surface of the motor terminal 23. The first through-hole 23a and the second through-hole 21a are vertically connected to each other. Therefore, the motor shaft 31 protruding vertically from the upper end of the driving motor 30 passes through the first and second through-holes 23a and 21a and is coupled to the upper portion of the installation space 13. The installation space 13 is divided into the upper portion and the lower portion by the blocking plate 20.

In addition, the rotational shaft S of the final output gear G of the decelerator 50 passes through a portion of the blocking plate 20, and the lower end of the rotational shaft S is coupled to the lower portion of the installation space 13. A magnet 41 is installed at the lower end of the rotational shaft S, which is coupled to the lower portion of the installation space 13. A sensor 43 is installed in the lower portion of the installation space 13 under the magnet 41. The magnet 41 and the sensor 43 installed as above constitute a sensor unit 40.

The sensor 43 is a contactless type and is installed under the magnet 41. The sensor 43 measures a rotation angle by sensing a variation of a flux which is generated when the magnet 41 is rotated with the rotation of the rotational shaft S.

The ECU 60 is disposed at the outer periphery of the housing 10. In particular, the ECU 60 is disposed at one side of the driving motor 30 under the sensor 43.

Since the blocking plate 20 divides the installation space 13 into the upper portion and the lower portion as described above, the decelerator 50 is separated from the driving motor 30, the sensor unit 40, and the ECU 60. Therefore, it is possible to prevent malfunction or performance degradation, which may be caused when foreign particles generated by the abrasion of the gear G and grease used in the gear G are introduced into the driving motor 30, the sensor unit 40, and the ECU 60. Moreover, since the sensor 43 has a contactless structure, the spatial limitation of the installation space 13 is structurally reduced. Therefore, it is easy to support both ends of the rotational shaft included in the decelerator 50. That is, it may be preferable that the rotational shaft S of the decelerator 50 is supported to the blocking plate 20.

Meanwhile, since the ECU 60 is separately installed at the outer periphery of the housing 10, water does not directly infiltrate into the ECU 60. Also, brush powder generated in the driving motor 30 does not adhere to grease used in the gear.

Referring to FIGS. 3A and 3B, a groove portion having an approximately ring shape is formed on the rear surface of the cover 11, such that the return spring 55 is inserted into and located at the groove portion. The groove portion is formed around the insertion hole 11a. A concave portion 11b is formed at one side of the groove portion. A stopper 11c protruding from the rear surface of the cover 11 is formed at the outer side of the groove portion.

One end 55a of the return spring 55 is disposed within the concave portion 11b to prevent the return spring 55 from being freely rotated. As shown in FIG. 3B, the other end 55b of the return spring 55 is fixed to a fixing portion Gb formed in the final output gear G. Accordingly, when seen in FIG. 3b, a restoring force is generated in the return spring 55 if the final output gear G rotates in a counterclockwise direction.

The final output gear G includes a protruding portion Ga having an approximately semicircular or fan shape. The rotation of the final output gear G may be restricted by the contact between the protrusion portion Ga and the stopper 11c.

According to the embodiments of the present invention, since the return spring 55 capable of assisting the retention force of the final output gear G is installed, an amount of a current consumed by the motor may be reduced, as compared to a case in which the rotation angle of the final output gear G is maintained by only the driving force of the motor. In addition, due to the interaction between the stopper 11c and the protrusion portion Ga of the final output gear which are formed on the rear surface of the cover 11, the final output gear G is not unnecessarily rotated by the elastic force of the return spring 55. Therefore, the rotation angle of the final output gear G may be restricted.

As described above, according to the embodiments of the present invention, the electric waste gate actuator includes the return spring for assisting the retention force of the final output gear, and the stopper for adjusting the rotation angle of the final output gear.

Accordingly, the electric waste gate actuator may reduce an amount of a current consumed for maintaining the final output gear at the constant position.

While the embodiments of the present invention has been described with reference to the specific embodiments, it will be apparent to those skilled in the art that various changes and modifications may be made without departing from the spirit and scope of the invention as defined in the following claims.

What is claimed is:

1. An electric waste gate actuator for a turbocharger, comprising:
a housing having an installation space formed by a body and a cover;
a driving motor installed within the installation space;
a decelerator including gear trains provided with a plurality of gears, such that the decelerator is coupled to a lever installed outside the housing and transmits power of the driving motor; and
an elastic member cooperating with the driving motor so as to maintain a rotation angle of a final output gear for finally transmitting power to the lever among the gear trains.

2. The electric waste gate actuator according to claim 1, wherein the cover comprises:
an insertion hole into which a rotational shaft of the final output gear is inserted; and
a groove portion formed around the insertion hole, such that the elastic member is disposed at the groove portion.

3. The electric waste gate actuator according to claim 2, wherein the elastic member is a coil spring, one end of which is disposed within a concave portion formed at one side of the groove portion, and the other end of which is fixed the final output gear, such that the coil spring generates a restoring force when the final output gear is rotated.

4. The electric waste gate actuator according to claim 1, wherein:
the cover comprises a stopper protruding on a rear surface thereof around an insertion hole in which a rotational shaft of the final output gear is inserted;
the final output gear comprises a protrusion portion; and
a rotation of the final output gear is restricted by a contact between the protrusion portion and the stopper.

5. The electric waste gate actuator according to claim 1, further comprising:
a magnet installed at one end of a rotational shaft of the final output gear within the housing;
a sensor installed in installation space under the magnet within the housing and measuring the rotation angle of the final output gear by sensing a variation in a flux of the magnet; and
an electronic control unit (ECU) installed in the housing outside the installation space.
